(19) United States
(12) Patent Application Publication
(10) Pub. No.: US 2024/0202785 A1
(43) Pub. Date: Jun. 20, 2024

(54) MACHINE LEARNING (ML) MODEL BASED LOW-BALL OFFER DETERMINATION

(71) Applicant: Honda Motor Co., Ltd., Tokyo (JP)

(72) Inventor: MATT KOMICH, Denver, CO (US)

(21) Appl. No.: 18/067,584

(22) Filed: Dec. 16, 2022

(51) Int. Cl. G06Q 30/0283; G06Q 30/0201; G06Q 30/0601

(52) U.S. Cl. CPC G06Q 30/0283; G06Q 30/0206; G06Q 30/0611

(57) ABSTRACT

A system and method for machine learning (ML) model based low-ball offer determination is provided. The system receives a first data set including a set of historical list prices for a first product, and a set of historical offer prices associated with the set of historical list prices. The system trains an ML model. The system receives a first list price, associated with a first seller. The system receives a first offer price, associated with a first buyer and the first list price. The system applies the trained ML model on the received first offer price. The system determines whether the received first offer price corresponds to a low-ball offer. The low-ball offer corresponds to an offer price that is a predefined value lesser than the determined threshold price for the first product. The system transmits a first notification corresponding to the first offer price from the first buyer.

### BACKGROUND

Typically, when anyone wants to sell a used product, such as, a vehicle, the seller may consider selling the product to another private party rather than selling or trading the used product to a dealer. This may be because the seller may gain more profit from a private party sale than from a sale through the dealer. However, selling the used product, e.g., a vehicle, to another private party may be an arduous process that may require a considerable amount of time and to-and-for communication between the seller and the prospective buyers. Sellers often complain of myriad issues associated with private party sales. Typically, the sellers may receive a number of offers for their used product that may be much lesser than an asking price of the used product. For example, the sellers may list their used product on a peer-to-peer marketplace. The buyers may view the listed vehicles and may send messages to the seller with an offer that may be far below the asking price. This may lead to loss of time of the sellers. Furthermore, the sellers may be agitated by dealing with buyers who make such low offers and may be driven towards selling the used product through lower priced deals. The lower priced deals may cause a financial loss to the seller and a may result in a distrust towards the second-hand product marketplace. This may also entice the seller to go through dealers to sell a used product in the future, which may cause further financial loss to the seller due to lower valued deals through the dealer.

Limitations and disadvantages of conventional and traditional approaches will become apparent to one of skill in the art, through comparison of described systems with some aspects of the present disclosure, as set forth in the remainder of the present application and with reference to the drawings.

### SUMMARY

An exemplary aspect of the disclosure provides a system. The system may include a control circuitry. The control circuitry may receive a first data set including a set of historical list prices for a first product, and a set of historical offer prices corresponding to the set of historical list prices. The control circuitry may train a machine learning (ML) model based on the received first data set. The control circuitry may receive a first list price, associated with a first seller, for the first product. The control circuitry may receive a first offer price, associated with a first buyer and associated with the first list price, for the first product. The control circuitry may apply the trained ML model on the received first offer price based on the received first list price to determine a threshold price for the first product. The control circuitry may determine whether the received first offer price corresponds to a low-ball offer based on the application of the trained ML model, wherein the low-ball offer may correspond to an offer price that may be a predefined value lesser than the determined threshold price for the first product. The control circuitry may transmit a first notification corresponding to the first offer price from the first buyer, based on the determination that the received first offer price corresponds to the low-ball offer.

Another exemplary aspect of the disclosure provides a method. The method may include reception of a first data set including a set of historical list prices for a first product, and a set of historical offer prices corresponding to the set of historical list prices. The method may include training a machine learning (ML) model based on the received first data set. The method may include reception of a first list price, associated with a first seller, for the first product. The method may include reception of a first offer price, associated with a first buyer and associated with the first list price, for the first product. The method may include application of the trained ML model on the received first offer price based on the received first list price to determine a threshold price for the first product. The method may include determining whether the received first offer price corresponds to a low-ball offer based on the application of the trained ML model, wherein the low-ball offer may correspond to an offer price that may be a predefined value lesser than the determined threshold price for the first product. The method may include transmission of a first notification corresponding to the first offer price from the first buyer, based on the determination that the received first offer price corresponds to the low-ball offer.

Another exemplary aspect of the disclosure provides a non-transitory computer-readable medium having stored thereon, computer-executable instructions. The computer-executable instructions that when executed by a system may cause the system to execute operations. The operations may include reception of a first data set including a set of historical list prices for a first product, and a set of historical offer prices corresponding to the set of historical list prices. The operations may include training a machine learning (ML) model based on the received first data set. The operations may include reception of a first list price, associated with a first seller, for the first product. The operations may include reception of a first offer price, associated with a first buyer and associated with the first list price, for the first product. The operations may include application of the trained ML model on the received first offer price based on the received first list price to determine a threshold price for the first product. The operations may include determining whether the received first offer price corresponds to a low-ball offer based on the application of the trained ML model, wherein the low-ball offer may correspond to an offer price that may be a predefined value lesser than the determined threshold price for the first product. The operations may include transmission of a first notification corresponding to the first offer price from the first buyer, based on the determination that the received first offer price corresponds to the low-ball offer.

### BRIEF DESCRIPTION OF THE DRAWINGS

FIG. 1 is a diagram that illustrates an exemplary network environment for a machine learning (ML) model based low-ball offer determination, in accordance with an embodiment of the disclosure.

FIG. 2 illustrates a block diagram of an exemplary system of FIG. 1, in accordance with an embodiment of the disclosure.

FIG. 3 is a diagram that illustrates an exemplary processing pipeline for ML model based low-ball offer determination, in accordance with an embodiment of the disclosure.

FIG. 4 is a diagram that illustrates an exemplary scenario for ML model based low-ball offer determination, in accordance with an embodiment of the disclosure.

FIG. 5 is a diagram that illustrates an exemplary scenario for determination of the low-ball offer based on an average offer price associated with buyers other than a first buyer, in accordance with an embodiment of the disclosure.

FIG. 6 is a diagram that illustrates an exemplary scenario for determination of the low-ball offer based on an average selling price associated with buyers other than a first buyer, in accordance with an embodiment of the disclosure.

FIG. 7 is a diagram that illustrates an exemplary scenario for a second notification transmission, in accordance with an embodiment of the disclosure.

FIG. 8 is a diagram that illustrates an exemplary scenario for a first notification transmission based on a difference between a first offer price and a first list price, in accordance with an embodiment of the disclosure.

FIG. 9 is a diagram that illustrates a flowchart of an exemplary method for ML model based low-ball offer determination, in accordance with an embodiment of the disclosure.

The foregoing summary, as well as the following detailed description of the present disclosure, is better understood when read in conjunction with the appended drawings. For the purpose of illustrating the present disclosure, exemplary constructions of the preferred embodiment are shown in the drawings. However, the present disclosure is not limited to the specific methods and structures disclosed herein. The description of a method step or a structure referenced by a numeral in a drawing is applicable to the description of that method step or structure shown by that same numeral in any subsequent drawing herein.

### DETAILED DESCRIPTION

The following described implementations may be found in a disclosed system and method of machine learning (ML) model based low-ball offer determination. Exemplary aspects of the disclosure provide a system that includes control circuitry that may receive a first data set including a set of historical list prices for a first product, and a set of historical offer prices corresponding to the set of historical list prices. The control circuitry may train a machine learning (ML) model based on the received first data set. Further, the control circuitry may receive a first list price, associated with a first seller, for the first product. The control circuitry may receive a first offer price, associated with a first buyer and associated with the first list price, for the first product. The control circuitry may apply the trained ML model on the received first offer price based on the received first list price to determine a threshold price for the first product. The control circuitry may determine whether the received first offer price corresponds to a low-ball offer based on the application of the trained ML model. The low-ball offer may correspond to an offer price that may be a predefined value lesser than the determined threshold price for the first product. The control circuitry may transmit a first notification corresponding to the first offer price from the first buyer, based on the determination that the received first offer price corresponds to the low-ball offer.

Typically, owners of a used product (such as, a vehicle, a household appliance, furniture, and the like) may sell the used product to a private party rather than selling or trading to a dealer because the owners may gain more profit from a private party sale than by a sale through the dealer. However, selling the used product, e.g., a vehicle, to another private party may be an arduous process that may require a considerable amount of time and to-and-for communication between the seller and the prospective buyers. Sellers may often complain of myriad issues associated with private party sales. The most common issue that the sellers may face is that the sellers may receive offers for the products to be sold at a price that may be unacceptably lower than an asking price of the product. Furthermore, the sellers may have to manage multiple chat conversations with potential buyers through various peer-to-peer marketplaces in order to sell the product. Considerable amount of time may be wasted by the seller to engage in a conversation with a potential buyer that may be making an unreasonably low offer. Such situations may be frustrating for the sellers and may drive the sellers to trade-in the product in spite of knowing that they may get less value because trading may an easier and a hassle-free option. Many sellers on peer-to-peer marketplaces may ask buyers not to present them with very low offers in their listing description in order to try and avoid low offers. However, such intimation from the sellers on the peer-to-peer marketplace may not still prevent the potential buyers from making offers that may be much less than the list price of the product.

The disclosed system may determine whether the received first offer price corresponds to the low-ball offer based on the application of the trained ML model. The disclosed system may transmit the first notification corresponding to the first offer price from the first buyer, based on the determination that the received first offer price corresponds to the low-ball offer. In case, the received first offer price corresponds to the low-ball offer, then the received first offer price may not be notified to the seller, such as, the first seller. Instead, the disclosed system may notify the buyer, such as, the first buyer, to provide an offer price that is not the low-ball offer. In case, the received first offer price does not correspond to the low-ball offer, the received first offer price may be notified to the seller such as, the first seller. Thus, the low-ball offers may be filtered for the sellers and such low ball offers may not be notified to the sellers. The filtering of the low ball offers may save the sellers from engaging in conversations with buyers who may not be willing to provide an acceptable value for the product one sale. Further, an amount of time spent to manually filter and screen the low-ball offers by the sellers may be also saved, which may in turn may encourage the sellers to sell the first product to third parties rather than dealers at better deals.

Reference will now be made in detail to specific aspects or features, examples of which are illustrated in the accompanying drawings. Wherever possible, corresponding or similar reference numbers will be used throughout the drawings to refer to the same or corresponding parts.

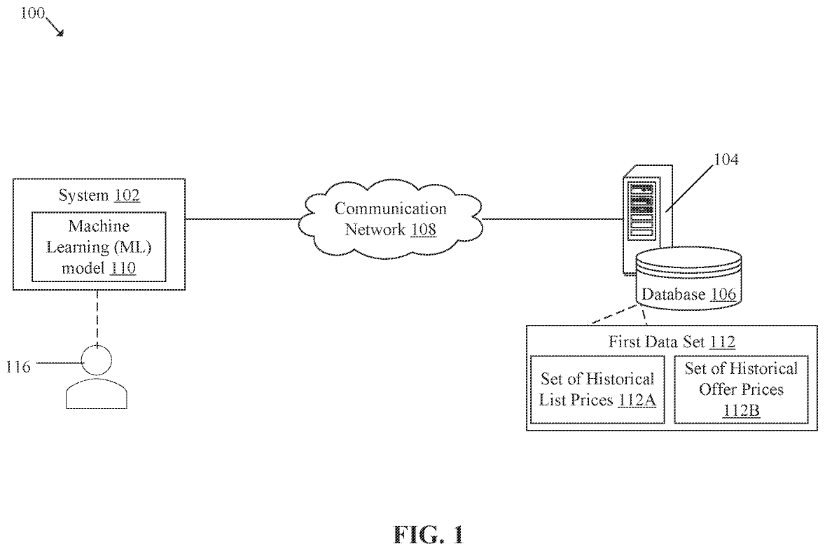

FIG. 1 is a diagram that illustrates an exemplary network environment for machine learning (ML) model based low-ball offer determination, in accordance with an embodiment of the disclosure. With reference to FIG. 1, there is shown an exemplary network environment 100. In the exemplary network environment 100, there is shown a system 102, a server 104, and a database 106. The system 102 and the server 104 may be communicatively coupled to each other via a communication network 108. The system 102 may include a machine learning (ML) model 110. The database 106 may be communicatively coupled to the server 104. The database 106 may include a first data set 112. The first data set 112 may include a set of historical list prices 112A and a set of historical offer prices 112B. There is further shown a user 114, who may be associated with the system 102 and/or may operate the system 102.

The system 102 may include suitable logic, circuitry, and interfaces that may be configured to receive a first data set (such as, the first data set 112) including a set of historical list prices (such as, the set of historical list prices 112A) for a first product, and a set of historical offer prices (such as, the set of historical offer prices 112B) corresponding to the set of historical list prices 112A. The system 102 may train the machine learning (ML) model 110 based on the received first data set 112. The system 102 may receive a first list price, associated with a first seller (such as, the user 114), for the first product. The system 102 may receive a first offer price, associated with a first buyer and associated with the first list price, for the first product. The system 102 may apply the trained ML model 110 on the received first offer price based on the received first list price to determine a threshold price for the first product. The system 102 may determine whether the received first offer price corresponds to a low-ball offer based on the application of the trained ML model 110. the low-ball offer may correspond to an offer price that may be a predefined value lesser than the determined threshold price for the first product. The system 102 may transmit a first notification corresponding to the first offer price from the first buyer, based on the determination that the received first offer price corresponds to the low-ball offer. Examples of the system 102 may include, but are not limited to, a computing device, a smartphone, a cellular phone, a mobile phone, a gaming device, a mainframe machine, a server, a computer work-station, and/or a consumer electronic (CE) device.

The server 104 may include suitable logic, circuitry, and interfaces, and/or code that may be configured to receive the first data set (such as, the first data set 112) including the set of historical list prices (such as, the set of historical list prices 112A) for the first product, and the set of historical offer prices (such as, the set of historical offer prices 112B) corresponding to the set of historical list prices 112A. The server 104 may train the machine learning (ML) model 110 based on the received first data set 112. The server 104 may receive the first list price, associated with the first seller (such as, the user 114), for the first product. The server 104 may receive the first offer price, associated with the first buyer and associated with the first list price, for the first product. The server 104 may apply the trained ML model 110 on the received first offer price based on the received first list price to determine the threshold price for the first product. The server 104 may determine whether the received first offer price corresponds to the low-ball offer based on the application of the trained ML model 110. The low-ball offer may correspond to an offer price that may be the predefined value lesser than the determined threshold price for the first product. The server 104 may transmit the first notification corresponding to the first offer price from the first buyer, based on the determination that the received first offer price corresponds to the low-ball offer. The server 104 may be implemented as a cloud server and may execute operations through web applications, cloud applications, HTTP requests, repository operations, file transfer, and the like. Other example implementations of the server 104 may include, but are not limited to, a database server, a file server, a web server, a media server, an application server, a mainframe server, or a cloud computing server.

In at least one embodiment, the server 104 may be implemented as a plurality of distributed cloud-based resources by use of several technologies that are well known to those ordinarily skilled in the art. A person with ordinary skill in the art will understand that the scope of the disclosure may not be limited to the implementation of the server 104 and the system 102 as two separate entities. In certain embodiments, the functionalities of the server 104 can be incorporated in its entirety or at least partially in the system 102, without a departure from the scope of the disclosure.

The database 106 may include suitable logic, interfaces, and/or code that may be configured to store the first data set 112 including the set of historical list prices 112A and the set of historical offer prices 112B. The database 106 may be derived from data off a relational or non-relational database. The database 106 may be stored or cached on a device, such as a server (such as, the server 104) or the system 102. The device that stores the database 106 may be configured to receive a query for the first data set 112 from the system 102 and/or the server 104. In response, the device of the database 106 may be configured to retrieve and provide the queried first data set 112 to the system 102 and/or the server 104, based on the received query.

In some embodiments, the database 106 may be hosted on a plurality of servers stored at same or different locations. The operations of the database 106 may be executed using hardware including a processor, a microprocessor (e.g., to perform or control performance of one or more operations), a field-programmable gate array (FPGA), or an application-specific integrated circuit (ASIC). In some other instances, the database 106 may be implemented using software.

The communication network 108 may include a communication medium through which the system 102 and the server 104 may communicate with each other. The communication network 108 may be one of a wired connection or a wireless connection Examples of the communication network 108 may include, but are not limited to, the Internet, a cloud network, a Cellular or Wireless Mobile Network (such as, Long-Term Evolution and 5G New Radio), a satellite communication network (such as, a network of a set of low-earth orbit satellites), a Wireless Fidelity (Wi-Fi) network, a Personal Area Network (PAN), a Local Area Network (LAN), or a Metropolitan Area Network (MAN). Various devices in the network environment 100 may be configured to connect to the communication network 108 in accordance with various wired and wireless communication protocols. Examples of such wired and wireless communication protocols may include, but are not limited to, at least one of a Transmission Control Protocol and Internet Protocol (TCP/IP), User Datagram Protocol (UDP), Hypertext Transfer Protocol (HTTP), File Transfer Protocol (FTP), Zig Bee, EDGE, IEEE 802.11, light fidelity (Li-Fi), 802.16, IEEE 802.11s, IEEE 802.11g, multi-hop communication, wireless access point (AP), device to device communication, cellular communication protocols, and Bluetooth (BT) communication protocols.

The machine learning (ML) model 110 may be a classifier or regression model which may be trained to identify a relationship between inputs, such as features in a training dataset and output labels. The ML model 110 may be trained based on the received first data set 112 to determine whether the received first offer price is the low-ball offer or not. The ML model 110 may be defined by its hyper-parameters, for example, number of weights, cost function, input size, number of layers, and the like. The parameters of the ML model 110 may be tuned and weights may be updated so as to move towards a global minimum of a cost function for the ML model 110. After several epochs of the training on the feature information in the training dataset, the ML model 110 may be trained to output a classification result for a set of inputs. The classification result may state whether the received first offer price is the low-ball offer or not.

The ML model 110 may include electronic data, which may be implemented as, for example, a software component of an application executable on the system 102. The ML model 110 may rely on libraries, external scripts, or other logic/instructions for execution by a processing device, such as the control circuitry. The ML model 110 may include code and routines configured to enable a computing device, such as control circuitry to perform one or more operations such as, determination of whether the received first offer price is the low-ball offer or not. Additionally, or alternatively, the ML model 110 may be implemented using hardware including a processor, a microprocessor (e.g., to perform or control performance of one or more operations), a field-programmable gate array (FPGA), or an application-specific integrated circuit (ASIC). Alternatively, in some embodiments, the ML model 110 may be implemented using a combination of hardware and software.

The first data set 112 may include the set of historical list prices 112A and the set of historical offer prices 112B. The set of historical list prices 112A may include a set of list prices made by a set of sellers other than the first seller for the products that may be similar to the first product. The set of historical offer prices 112B may include a set of offer prices made by a set of buyers other than the first buyer for the products that may be similar to the first product. The set of historical list prices 112A and the set of historical offer prices 112B may be used to train the ML model 110.

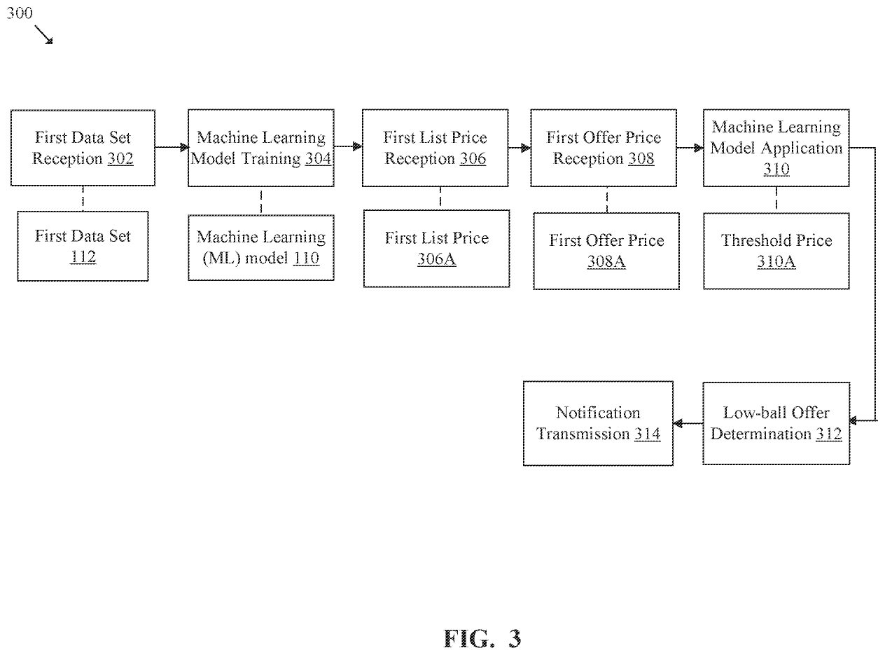

In operation, the system 102 may receive the first data set 112 including the set of historical list prices 112A for the first product, and the set of historical offer prices 112B corresponding to the set of historical list prices 112A. The first product may be a used product (such as, a used vehicle, a household appliance, furniture, and the like) that the first seller may want to sell off. The set of historical list prices 112A may be the list prices at which the set of sellers may have listed products similar to the first product on a virtual marketplace in the past. The set of historical offer prices 112B may be first offer prices for the products similar to the first product that the set of buyers may have made in the past on the virtual marketplace. The set of historical list prices 112A and the set of historical offer prices 112B may be received from the database 106. Details about the set of historical list prices 112A and the set of historical offer prices 112B are further provided, for example, in FIG. 3 (at 302).

The system 102 may train the machine learning (ML) model 110 based on the received first data set 112. The ML model 110 may be trained to determine the threshold price. The trained ML model may further be used to determine whether the first offer price received from the first buyer is the low-ball offer or not. Details about the training of the machine learning (ML) model 110 are further provided, for example, in FIG. 3 (at 304).

The system 102 may receive the first list price, associated with the first seller, for the first product. The first list price may be a first price at which the first seller may have listed the first product at a first time instant. It may be appreciated that the sellers may often change the list price based on a market situation. However, the first list price may be a list price at which the first seller may have listed the first product initially. Details about the first list price are further provided, for example, in FIG. 3 (at 306).

The system 102 may receive the first offer price, associated with the first buyer and associated with the first list price, for the first product. The first offer price may be a first price that the first buyer may quote for the first product at a second time instant, which may be after the first time instant. It may be appreciated that the first offer price may be lesser than the first list price. It may be noted that the buyers may often change the offer price based on whether or not the last offer price is the low-ball offer or not. However, the first offer price may be an offer price made by the first buyer for the first product initially. Details about the first offer price are further provided, for example, in FIG. 3 (at 308).

The system 102 may apply the trained ML model 110 on the received first offer price based on the received first list price to determine the threshold price for the first product. The threshold price may be a certain price that may be denoted in parameters such as, a percentage, an average, a difference, and the like. In an embodiment, the threshold price may be below the received first list price. The determined threshold price for the first product may correspond to an average offer price (for the first product) made by other buyers or an average selling price at which other buyers may have purchased other products similar to the first product. In some cases, the determined threshold price for the first product may correspond an average offer price made by the first buyer to other sellers for the products similar to the first product. Details about the application of the trained ML model 110 are further provided, for example, in FIG. 3 (at 310).

The system 102 may determine whether the received first offer price corresponds to the low-ball offer based on the application of the trained ML model 110. The low-ball offer may correspond to the offer price that may be the predefined value lesser than the determined threshold price for the first product. The trained ML model 110 may compare the received first offer price with the determined threshold price to determine whether the received first offer price is the low-ball offer or not. Details about the determination of the low-ball offer are further provided, for example, in FIG. 3 (at 312).

The system 102 may transmit the first notification corresponding to the first offer price from the first buyer, based on the determination that the received first offer price corresponds to the low-ball offer. The first notification may be either sent to the first buyer and/or may be sent to the first seller depending on whether or not the received first offer price corresponds to the low-ball offer. In case the received first offer price is determined as the low-ball offer, the first notification may be transmitted to a buyer device associated with the first buyer. In case the received first offer price is not determined as the low-ball offer, the first notification may be transmitted to a seller device associated with the first seller. Details about the first notification are further provided, for example, in FIG. 3 (at 314).

Thus, the system 102 may determine whether the received first offer price corresponds to the low-ball offer. The system 102 may transmit the first notification corresponding to the first offer price from the first buyer, based on the determination that the received first offer price corresponds to the low-ball offer. In case, the received first offer price corresponds to the low-ball offer, then the received first offer price may not be notified to the seller such as, the first seller. In such cases, the system 102 may notify the buyer such as, the first buyer to provide an offer price that is not the low-ball offer. In case, the received first offer price does not correspond to the low-ball offer, the received first offer price may be notified to the seller such as, the first seller. Thus, the low-ball offers may be automatically filtered and may not be sent to the sellers. The sellers may be thereby saved from engaging in conversations with buyers corresponding to unacceptably low value offers (i.e., the low ball offers). As such, it may be appreciated that the seller may not be likely to accept a deal for such low ball offers. Further, it may be unlikely that the buyers making such low ball offers may make acceptable future offers for the first product if the seller decides to negotiate with such buyers. Thus, the sellers may be able to save time associated with manual filtering of the low-ball offers by the sellers. Further, the sellers may be prevented from engaging in communication with buyers who may not provide good price for the product. Thus, the sellers may be able to sell the first product to third parties rather than dealers at better prices and in a timely manner, based on the automatic filtering of the low ball offers by the disclosed system 102.

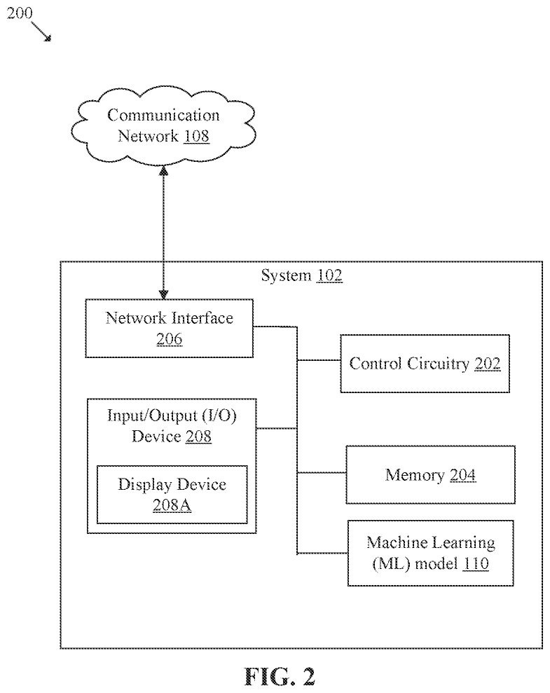

FIG. 2 is a block diagram of an exemplary communication device of FIG. 1, in accordance with an embodiment of the disclosure. FIG. 2 is explained in conjunction with elements from FIG. 1. With reference to FIG. 2, there is shown a block diagram 200 of the system 102. The system 102 may include control circuitry 202, a memory 204, a network interface 206, an input/output (I/O) device 208 (comprising a display device 208A), and the ML model 110. Although in FIG. 2, it is shown that the system 102 includes the control circuitry 202, the memory 204, the network interface 206, the ML model 110, and the input/output (I/O) device 208; however, the disclosure may not be so limiting, and the system 102 may include less or more components to perform the same or other functions of the system 102. Details of the other functions or components have been omitted from the disclosure for the sake of brevity.

The control circuitry 202 may include suitable logic, circuitry, and interfaces that may be configured to execute program instructions associated with different operations. For example, the operations may include, but are not limited to, first data set reception, ML model training, first list price reception, first offer price reception, ML model application, low-ball offer determination, notification transmission. The control circuitry 202 may include one or more specialized processing units, which may be implemented as a separate processor. In an embodiment, the one or more specialized processing units may be implemented as an integrated processor or a cluster of processors that perform the functions of the one or more specialized processing units, collectively. The control circuitry 202 may be implemented based on a number of processor technologies known in the art. Examples of implementations of the control circuitry 202 may be an X86-based processor, a Graphics Processing Unit (GPU), a Reduced Instruction Set Computing (RISC) processor, an Application-Specific Integrated Circuit (ASIC) processor, a Complex Instruction Set Computing (CISC) processor, a microcontroller, a central processing unit (CPU), and/or other control circuits.

The memory 204 may include suitable logic, circuitry, and interfaces that may be configured to store the one or more instructions to be executed by the control circuitry 202. The one or more stored instructions may be executable by the control circuitry 202 to perform the operations of the control circuitry 202 (or the system 102). The memory 204 that may be configured to store the first data set 112 including the set of historical list prices 112A and the set of historical offer prices 112B. The memory 204 may be a persistent storage medium, a non-persistent storage medium, or a combination thereof. Examples of implementation of the memory 204 may include, but are not limited to, Random Access Memory (RAM), Read Only Memory (ROM), Electrically Erasable Programmable Read-Only Memory (EEPROM), Hard Disk Drive (HDD), a Solid-State Drive (SSD), a CPU cache, and/or a Secure Digital (SD) card.

The network interface 206 may include suitable logic, circuitry, and interfaces that may be configured to facilitate communication between the control circuitry 202 of the system 102 and the server 104, via the communication network 108. The network interface 206 may be implemented by use of various known technologies to support wired or wireless communication of the system 102 with the communication network 108. The network interface 206 may include, but is not limited to, an antenna, a radio frequency (RF) transceiver, one or more amplifiers, a tuner, one or more oscillators, a digital signal processor, a coder-decoder (CODEC) chipset, a subscriber identity module (SIM) card, or a local buffer circuitry.

The network interface 206 may be configured to communicate via wireless communication with networks, such as the Internet, an Intranet, or a wireless network, such as a cellular telephone network, a wireless local area network (LAN), and a metropolitan area network (MAN). The wireless communication may be configured to use one or more of a plurality of communication standards, protocols and technologies, such as Global System for Mobile Communications (GSM), Enhanced Data GSM Environment (EDGE), wideband code division multiple access (W-CDMA), Long Term Evolution (LTE), code division multiple access (CDMA), time division multiple access (TDMA), 5^{th} Generation New Radio (5G-NR), Bluetooth, Wireless Fidelity (Wi-Fi) (such as IEEE 802.11a, IEEE 802.11b, IEEE 802.11g or IEEE 802.11n), voice over Internet Protocol (VOIP), light fidelity (Li-Fi), Worldwide Interoperability for Microwave Access (Wi-MAX), a protocol for email, instant messaging, and a Short Message Service (SMS).

The input/output (I/O) device 208 may include suitable logic, circuitry, and interfaces that may be configured to receive an input from the user (such as, the user 114) and provide an output based on the received input. For example, the I/O device 208 may receive a user input indicative of the first list price for the first product from the first seller. The I/O device 208 may display the first list price and the first product on the buyer device associated with the first buyer. Further, the I/O device 208 may receive a user input indicative of the first offer price for the first product from the first buyer. In an embodiment, the I/O device 208 may display a notification indicative of whether the first offer corresponds to a low ball offer on the seller device and/or the buyer device. The I/O device 208 which may include various input and output devices, may be configured to communicate with the control circuitry 202. Examples of the I/O device 208 may include, but are not limited to, a touch screen, a keyboard, a mouse, a joystick, a microphone, a display device, and a speaker.

The display device 208A may include suitable logic, circuitry, and interfaces that may be configured to display the first product, the received first list price, the received first offer price, the determined threshold, and/or the first notification. The display device 208A may be a touch screen which may enable a user to provide a user-input via the display device 208A. The touch screen may be at least one of a resistive touch screen, a capacitive touch screen, or a thermal touch screen. The display device 208A may be realized through several known technologies such as, but not limited to, at least one of a Liquid Crystal Display (LCD) display, a Light Emitting Diode (LED) display, a plasma display, or an Organic LED (OLED) display technology, or other display devices. In accordance with an embodiment, the display device 208A may refer to a display screen of the in-vehicle infotainment (IVI) system, the in-car entertainment (ICE) system, the smartphone, the computer workstation, the handheld computer, the cellular/mobile phone, the portable consumer electronic (CE) device, a smart-glass device, a see-through display, a projection-based display, an electro-chromic display, or a transparent display.

The functions or operations executed by the system 102, as described in FIG. 1, may be performed by the control circuitry 202. Operations executed by the control circuitry 202 are described in detail, for example, in FIG. 3.

FIG. 3 is a diagram that illustrates an exemplary processing pipeline for ML model based low-ball offer determination, in accordance with an embodiment of the disclosure. FIG. 3 is explained in conjunction with elements from FIG. 1 and FIG. 2. With reference to FIG. 3, there is shown an exemplary processing pipeline 300 that illustrates exemplary operations from 302 to 314 for ML model (e.g., the ML model 110) based low-ball offer determination. The exemplary operations 302 to 314 may be executed by any computing system, for example, by the system 102 of FIG. 1 or by the control circuitry 202 of FIG. 2. The exemplary processing pipeline 300 further illustrates the first data set 112, the machine learning model 110, a first list price 306A, a first offer price 308A, and a threshold price 310.

At 302, an operation for a first data set reception may be executed. The control circuitry 202 may be configured to receive the first data set 112 including the set of historical list prices 112A for the first product, and the set of historical offer prices 112B corresponding to the set of historical list prices 112A. The first product may be any used product that a seller associated with the first product may want to sell. Examples of the first product may include, but are not limited to, a vehicle, a computing device, a speaker device, a household appliance, or furniture. A list price may be a price at which the seller may list the first product on a platform for sale. The platform may be a peer-to-peer marketplace where different sellers may advertise their products for sale. Different sellers may advertise the first product on the platform at a different list price. The set of historical list prices 112A may be the list prices at which the set of sellers may have advertised respective first products on the platform in the past. An offer price may be a first offer made by the buyer for the first product. When the seller lists the first product on the platform, the buyer may make the first offer for the first product. The first offer may be less than the list price at which the first product may be listed by the seller on the platform. Different buyers may make different offer prices for first product on the platform. The set of historical offer prices 112B may be the offer prices for the first product, which the set of buyers may have made in the past.

In an embodiment, the first product may be a vehicle associated with vehicle information including at least one of a make, a model, a year, and a condition, associated with vehicle. The vehicle may be a used vehicle that the seller may want to sell off. The make may be a brand associated with the vehicle. The model may be a model number associated with the vehicle. The year may be a year of manufacture or a year of purchase of the vehicle. The condition may specify a working condition, an interior condition, and an exterior condition associated with the vehicle. The working condition may specify whether each functionality of the vehicle is working or not. The interior condition may state the condition of a cabin of the vehicle. For example, the interior condition may specify condition of seats of the vehicle. The exterior condition may state the condition of an exterior body of the vehicle. For example, the exterior condition may specify dents on the vehicle. The historical list prices 112A for the vehicle and the set of historical offer prices 112B corresponding to the set of historical list prices 112A for vehicles may differ based on the vehicle information associated with the vehicles. For example, the vehicle with poor condition may have a lower list price and a lower offer price than the vehicle of same make, model, and year but in a better condition.

At 304, an operation for a machine learning (ML) model training may be executed. The control circuitry 202 may be configured to train the machine learning (ML) model 110 based on the received first data set 112. The ML model 110 may be trained to determine the threshold price. The received set of historical list prices 112A for the first product and the received set of historical offer prices 112B corresponding to the received set of historical list prices 112A for the first product may be used to train the ML model 110. The training of the ML model 110 may correspond to a supervised learning, a semi-supervised learning, or an unsupervised learning technique. In an embodiment, the ML model 110 may be trained to learn what the ‘low-ball’ offer is by learning a value of an average offer below the list price. For example, the ML model 110 may be trained with ‘5000’ examples of offer prices for a vehicle with a specific make, model, year, and condition. Some peer-to-peer marketplaces may offer a feature that may allow buyers to make the offer price to the seller via chat. Herein, the ML model 110 may be trained to understand a selling price for the list price and determine the offer price made by the buyer. For example, the ML model 110 may conclude that for the vehicle of a specific make, model, year, and condition, an average offer price under the list price may be 8% based on the 5,000 offers on which the ML model 110 is trained. In other words, for the 5000 past offers for the vehicle, on an average, the offer price is 8% below the list price of the vehicle. Thus, the ML model 110 may be trained to predict the threshold price associated with the vehicle, based on the average offer price of 8% below the list price of the vehicle. For example, if the list price of the vehicle is USD 100,000, the ML model 110 may be trained to predict the threshold price as USD 92,000 (i.e., 8% below the list price of the vehicle).

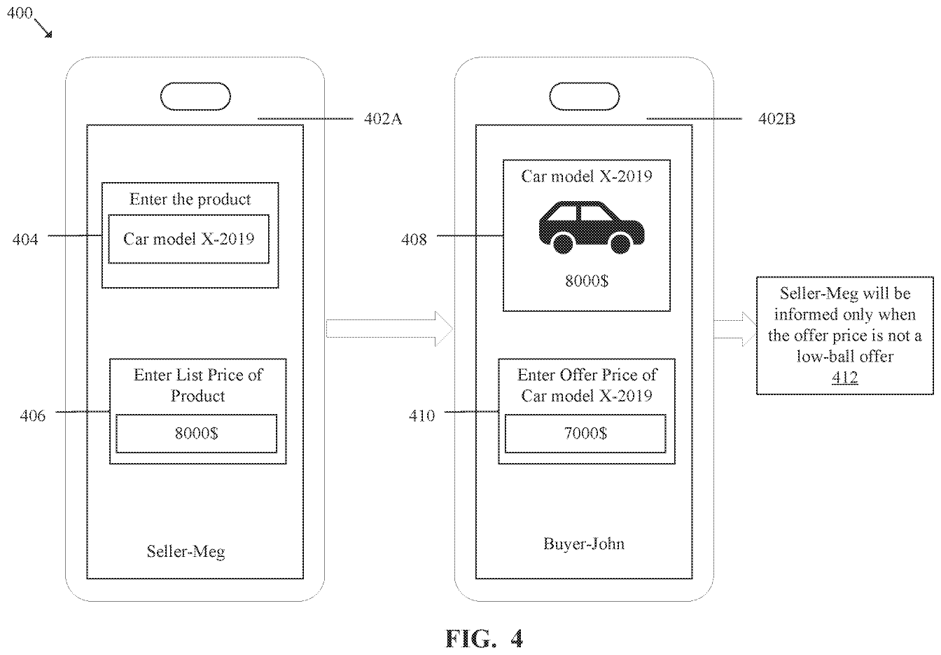

At 306, an operation for a first list price reception may be executed. The control circuitry 202 may be configured to receive the first list price 306A, associated with the first seller, for the first product. The first list price 306A may be the first price at which the first seller may have listed the first product on the platform for resale (i.e., a sale after use or a refurbished sale). In an example, a user interface (UI) element may be provided on the platform. The first seller may provide the first list price of the first product in the UI element. The first product may be then advertised on the platform with the first list price to attract the buyers. An example user interface associated with the reception of the first list price is described further, for example, in FIG. 4.

At 308, an operation for a first offer price reception may be executed. The control circuitry 202 may be configured to receive the first offer price 308A, associated with the first buyer and associated with the first list price 306A, for the first product. The first offer price 308A may be a first offer or a first quoted price that the first buyer may make for the first product. The first offer price 308A may be lesser than or equal to the first list price 306A. In an example, the first product may be advertised on the platform with the first list price. A user interface (UI) element may be provided on the platform. The first buyer may select the first product and may provide the first offer price for the first product in the UI element. For example, the first list price 306A for the first product may be “4000” dollars. The first buyer may provide the first offer price 308A for the first product as “3500” dollars. An example user interface associated with the reception of the first offer price is described further, for example, in FIG. 4.

At 310, an operation for an ML model application may be executed. The control circuitry 202 may be configured to apply the trained ML model 110 on the received first offer price 308A based on the received first list price 306A to determine the threshold price 310A for the first product. The threshold price may be a certain percent of price below the received first list price 306A.

In an embodiment, the determined threshold price 310A for the first product may correspond to an average offer price below the first list price 306A for the first product. The average offer price may be an average of offer prices of the set of buyers or first quoted price from other buyers of similar products below the first list price. The set of historical offer prices 112B may include offer prices quoted by the set of buyers for products similar to the first product. An average of the set of historical offer prices 112B may be determined in such cases to determine the average offer price. The threshold price 310A may be then determined based on a percentage by which the average offer price is below the first list price 306A. In an example, the received set of historical offer prices 112B may be “1900 dollars”, “2100 dollars”, and “2300 dollars”, which may be made by three different buyers for the products similar to the first product. The first list price 306A may be “2400 dollars” for the first product. Thus, the average offer price for the products similar to the first product may be “2100 dollars”. Thus, the threshold price 310A be determined as “12.5” percent. That is, the average offer price may be “12.5” percent less than the first list price 306A.

In an embodiment, the first data set 112 may further include a set of historical selling prices associated with a set of buyers, for the first product. The determined threshold price for the first product may correspond to an average selling price, provided by the set of buyers, below the first list price for the first product. Herein, the selling price may be an actual price at which the first product may be sold. Different buyers may purchase the products similar to the first product at a different selling prices. The set of historical selling prices may be the selling prices at which the set of buyers may have purchased products similar to the first product in the past. In an example, the set of historical selling prices may be “3100 dollars”, “2800 dollars”, and “2920 dollars” made by three different buyers for the products similar to the first product in the past. The first list price 306A may be “3300 dollars” for the first product. Thus, the average selling price for the first product may be “2940 dollars”. Thus, the threshold price 310A be determined as “11” percent. That is, the average selling price may be “11” percent less than the first list price 306A.

In an embodiment, the first data set 112 may include a set of historical offer prices associated with the first buyer for the first product. The threshold price for the first product may correspond to an average offer price, provided by the first buyer, below the first list price for the first product. The set of historical offer prices may be the first offer prices made by the first buyer for products similar to first product. In an example, the set of historical offer prices may be “3210 dollars”, “2700 dollars”, and “2820 dollars” made by the first buyer for the products similar to the first product in the past. The first list price 306A may be “3500 dollars” for the first product. Thus, the average offer price of the first buyer for the first product may be “2910 dollars”. It may be noted that the set of historical offer prices may be first offers made to sellers and the average selling price may not be calculated from second offers to a same seller. In the current example, the threshold price 310A may be determined as “17” percent. That is, the average offer price may be “17” percent less than the first list price 306A. In an embodiment, in order to determine the average offer price, the first buyer may need to have made at least three offers in the past. It may be noted that when a buyer, such as, the first buyer, may sign up for a service connecting private buyers and sellers, then the first buyer may make an offer to say, three sellers. The first offer may be “10%” under the list price, the second offer may be “17%” below the list price, and the third offer may be “21%” under the list price. After making three offers, the first buyer may make offers at an average of “14%” under the list price. In this example, if the first buyer approaches another seller, such as the first seller, then the first seller may see a flag that may notify the first seller of the average the offer that the first buyer makes below the list price. In current example, the first seller may be notified that, on an average, the first buyer may make an offer 17% below the list price of the first product.

At 312, an operation for a low-ball offer determination may be executed. The control circuitry 202 may be configured to determine whether the received first offer price 308A corresponds to the low-ball offer based on the application of the trained ML model 110. The low-ball offer may correspond to the offer price that may be a predefined value lesser than the determined threshold price for the first product. The trained ML model 110 may compare the received first offer price 308A with the determined threshold price. If the received first offer price 308A is the predefined value lesser than the determined threshold price, then the received first offer price 308A may be determined as the low-ball offer. In an example, the predefined value may be “10%” lesser than the first list price 306A. As an example, if the received first offer price 308A is lesser than the determined threshold price by more than “10%”, then the received first offer price 308A may be determined as the low-ball offer.

At 314, an operation for a first notification transmission may be executed. The control circuitry 202 may be configured to transmit the first notification corresponding to the first offer price 308A from the first buyer, based on the determination that the received first offer price 308A corresponds to the low-ball offer. The first notification may be in the form of an audio signal, a light signal, a pop-up notification, a haptic signal, and the like. The first notification may be sent either sent to the first buyer or the first seller depending on whether or not the received first offer price 308A corresponds to the low-ball offer.

In an embodiment, the first notification may be transmitted to the seller device related to the first seller if the first offer price 308A does not correspond to the low-ball offer. The seller device may be a system such as, the system 102, that may be associated with the first seller. In case, the first offer price 308A is determined as not a low-ball offer, then the first seller may receive the first notification and the first seller may then communicate with the first buyer to finalize the deal.

In an embodiment, the first notification may be transmitted to the buyer device related to the first buyer if the first offer price corresponds to the low-ball offer. The buyer device may be a system such as, the system 102, that may be associated with the first buyer. In an example, ML model 110 may be trained to learn that a low ball offer may be any offer that is “10%” lower than an average offer for the products similar to the first product. When the first buyer tries to make an offer with the first offer price 308A to the first seller, then the ML model 110 may determine that the first offer price 308A corresponds to the low-ball offer based on the aforementioned criteria. In such cases, the first offer price 308A may not be communicated to the first seller. The first buyer may receive the first notification, via an automated chat system, that the first offer price 308A is the low-ball offer and that the first seller will not be notified. Further, the first buyer may be suggested a minimum price that must be offered for the first offer price 308A to be notified the seller. Thus, the system 102 may make the process of selling the products easier for sellers as the sellers may not be bogged down by low-ball offers. Hence, the sellers may not have to waste time to filter low-ball offers.

In an embodiment, the control circuitry 202 may be configured to determine a difference between the received first offer price 308A and the received first list price 306A. The transmitted first notification may further indicate the determined difference between the received first offer price 308A and the received first list price 306A. The received first offer price 308A may be lesser than the received first list price 306A. The received first offer price 308A may be subtracted from the received first list price 306A to determine the difference. The difference may be then transmitted as the first notification. In an example, the received first offer price 308A may be “3000 dollars” and the received first list price 306A may be “3700 dollars”. The difference may be determined as “700 dollars”. Herein, the difference may be indicated in the transmitted first notification. For example, the first seller may be notified of the received first offer price 308A and the difference. The indication of the difference may help the first seller to understand how less the received first offer price 308A is from the received first list price 306A. Thus, the first seller may make better decision. In addition, in a percentage of the difference, with respect to the first list price 306A, may also be indicated in the first notification. For example, in case the first list price 306A is “3700 dollars” and the first offer price 308A is “3000 dollars”, the difference may be “700 dollars” and the percentage of the difference (with respect to the first list price 306A) may be 18.92% (i.e., 700/3700*100).

It may be noted that the ML model 110 may be capable of averaging all offers made by buyers that may be filtered by physical location. In some cases, the sellers, such as, the first seller may be interested to deal with local buyers. In such cases, when the seller such as, the first seller, signs up on a marketplace to list their products such as, the first product, then the seller may define a preferred radius. The preferred radius may be a geographical area within which the seller may be interested to sell the first product. That is, the seller may be interested in buyers whose physical location may be within the predefined radius. For example, the seller may be interested in buyers that may be within a 30-mile radius of the seller's location, so that it may be easy for the seller to meet the buyers in-person. Therefore, the seller may be approached by buyers that may be within the 30-mile radius. The ML model 110 may notify the seller of the average offers from buyers for products similar to the first product within the 30-mile radius. Such notification may allow the seller to expand a radius of search for the buyers in case the expansion of radius benefits the sellers. For example, the first seller may be selling the first product in a first location and a second location. The first seller may have filtered the radius to five miles so that only offers from buyers in the first location or the second location may be notified to the first seller. In some cases, buyers in an adjacent county may make offers that may be higher than the offers made by the buyers in the filtered radius. For example, the buyers in the third location may make offers that may be on an average “5%” closer to the first list price 306A than the buyers in the first location. Such cases may prompt the first seller to expand the radius and get notified of offers from buyers that may be further away in physical distance in order to get a better value for the first product.

In an embodiment, the control circuitry 202 may be configured to receive first location information associated with the first seller. The control circuitry 202 may be further configured to receive second location information associated with the first buyer. The control circuitry 202 may be further configured to compare the second location information with the first location information. The transmission of the first notification may be further based on the comparison of the second location information and the first location information. The first location information may be the radius or geographical areas within which the first seller may want to sell the first product. The second location information may include for example, an address of the first buyer. The control circuitry 202 may compare the second location information with the first location information. In an example, the first location information may include the predefined radius and the address associated with the first seller. For example, the address of the first buyer may be compared with the address associated with the first seller to determine whether the address of the first buyer lies within the predefined radius from the address of the first seller. In case, the address of the first buyers lies within the predefined radius (as per the first location information), then the first offer price 308A may be notified to the first seller.

In some embodiments, the sellers (such as, the first seller) and buyers (such as, the first buyer) may be requested to provide respective home address, county, or city in which the sellers and buyers reside. The ML model 110 determine the average offers that the seller such as, the first seller, may receive in a particular city and county. Further, the ML model 110 may notify the first seller in case a nearby city or county is a host to buyers that make better offers to sellers on an average. Additionally, sellers may be able to view a web page that may display the average offers (below the list price) that buyers in a specific city, county, or state make to sellers. The sellers may toggle any combination of city, county, state, zip code, buyer age, vehicle year, vehicle make, vehicle model, and more to check for best deals. For example, the first seller may filter for offers for “2019 X vehicle” in a first geographical area from buyers aged twenty-five to forty-five.

In an embodiment, the control circuitry 202 may be further configured to categorize the first buyer into a buyer category of a set of buyer categories based on the determined threshold price 310A for the first product and on the average offer price provided by the first buyer. The control circuitry 202 may be further configured to transmit a second notification indicative of the buyer category associated with the first buyer. In an example, the set of buyer categories may include a first buyer category (e.g., a “category-1”), a second buyer category (e.g., a “category-2”), and a third buyer category (e.g., a “category-3”).

For example, the buyers, such as the first buyer, may be ‘tagged’ or categorized based on the average offer price that they may have made in the past to sellers such as, the first seller, below the list price, such as, the first list price 306A for the products similar to the first product. Buyers may typically not make any offers over the list price, so the average offer price may be useful to as a benchmark price point underneath the list price that may be offered by the buyers. In an example, if a buyer such as, the first buyer, makes offers, on average is “21%” or lower than the list price, then the buyer may be categorized into a “category-1”. If a buyer makes offers, on average, that may be “6%” to “20%” lower than the list price, then the buyer may be categorized into a “category-2”. If a buyer such as, the first buyer, makes offers on average, that may be “0%” to “5%” lower than the listing price, then the buyer may be categorized into a “category-3”. Thus, the seller such as, the first seller may get to know a category of the buyer such as, the first buyer even before the first buyer may make the first offer price 308A for the first product based on an average offer price that the buyer may generally make. Once the category of the first buyer is determined, the second notification indicative of the buyer category associated with the first buyer may be transmitted.

In an embodiment, the control circuitry 202 may be further configured to update the first data set 112 based on the received first list price 306A and the received first offer price 308A associated with the received first list price 306A. Further, the control circuitry 202 may re-train the ML model 110 based on the updated first data. The received first list price 306A may be included in the first data set 112. For example, the received first list price 306A may be included in the set of historical list prices 112A to obtain updated set of historical list prices. The received first offer price 308A associated with the received first list price 306A may be included in the set of historical offer prices 112B to obtain updated set of historical prices. The ML model 110 may be then retrained based on the updated set of historical list prices and the updated set of historical prices. For example, to re-train the ML model 110, the weights or other hyperparameters of the ML model 110 may be adjusted in one or more training iterations such that a loss function associated with the training process is minimized.

In an embodiment, the control circuitry 202 may be further configured to recommend a list price (or an offer price) range for a product (e.g., a vehicle) available for sale through an online portal, based on application of the ML model 110 on various factors. Examples of the factors that may be input to the ML model 110 may include, but are not limited to, specifications (e.g., model, year of manufacture, working condition, features, image etc.) of the vehicle, quoted prices (e.g., average prices quoted by sellers or buyers) of other vehicles with similar specifications, and final selling prices of the similar vehicles that may be sold through the online portal.

In an embodiment, the recommended list price (or offer price) range may be available to both the buyer and the seller of the product (e.g., the vehicle) through the online portal. In some scenarios, the online portal may charge fees from the seller to display the recommended list price range to the seller, however, the online portal may not charge any fees from the buyer to show the recommended offer price range. In other scenarios, the online portal may charge fees to from both the sellers and the buyers to display the recommended list price range and the recommended offer price range, respectively. In an embodiment, control circuitry 202 may re-train the ML model 110, based on at least one of, but not limited to, the recommended list price range (or offer price range) of the product (e.g., the vehicle), a price quoted by the seller, offer prices of potential buyers, and/or a final selling price of the product (in case of sale closure).

FIG. 4 is a diagram that illustrates an exemplary scenario for ML model based low-ball offer determination, in accordance with an embodiment of the disclosure. FIG. 4 is explained in conjunction with elements from FIG. 1, FIG. 2, and FIG. 3. With reference to FIG. 4, there is shown an exemplary scenario 400. The exemplary scenario 400 may include a seller device 402A associated with a first seller (such as, “Meg”) and a buyer device 402B associated with a first buyer (such as, “John”). The seller device 402A may display a first UI element 404 and a second UI element 406. The buyer device 402B may display a third UI element 408 and a fourth UI element 410. The seller device 402A and the buyer device 402B may be computing devices. However, the seller device 402A and the buyer device 402B may be similar to the system 102 and may incorporate functionalities of the system 102. The exemplary scenario 400 may further include an intermediate operation 412. A set of operations associated with the exemplary scenario 400 is described herein.

With reference, to FIG. 4, the first seller (e.g., “Meg”) may advertise the first product for sale through the first UI element 404. For example, the first product may correspond to a “Car model X-2019”. In some cases, the first UI element 404 may include a drop-down menu using which the first seller (e.g., “Meg”) may select the “Car model X-2019”. Further, the first seller (e.g., “Meg”) may input the first list price for the “Car model X-2019” (such as, a list price of “8000$”), through the second UI element 406. In some cases, the second UI element 406 may include a drop-down menu through which the first seller (e.g., “Meg”) may select the first list price (such as, “8000$”). The received first list price and the first product may be advertised or displayed on a display (such as, the display device 208A of FIG. 2) of the buyer device 402B. The third UI element 408 may display the “Car model X-2019” and the list price as “8000$”. The first buyer (e.g., “John”) may view the first list price for the “Car model X-2019” as “8000$” and may provide the first offer price (for example, as “7000$”) as an input through the fourth UI element 410. In some cases, the fourth UI element 410 may include a drop-down menu and the first buyer (e.g., “John”) may select the first offer price (such as, “7000$”) through the drop-down menu. Thereafter, the control circuitry 202 may determine whether the received first offer price (i.e., “7000$”) corresponds to a low-ball offer.

At operation 412, the first seller (e.g., “Meg”) may be informed of an incoming offer from the first buyer (e.g., “John”) in case the received first offer price (i.e., “7000$”) is not a low-ball offer. As discussed, for example, in FIG. 3 (at 314), the first seller (e.g., “Meg”) may be informed of the received first offer price only when the received first offer price is not the low-ball offer. Thus, the first seller “Meg” may not have to deal with buyers that offer low-ball prices for the first product (i.e., “Car model X-2019”). Further, time needed to deal with buyers with low-ball offers may be saved. Thus, the process for sale of the first product may become more time efficient and hassle-free for the sellers.

It should be noted that the scenario 400 of FIG. 4 is for exemplary purpose and should not be construed to limit the scope of the disclosure.

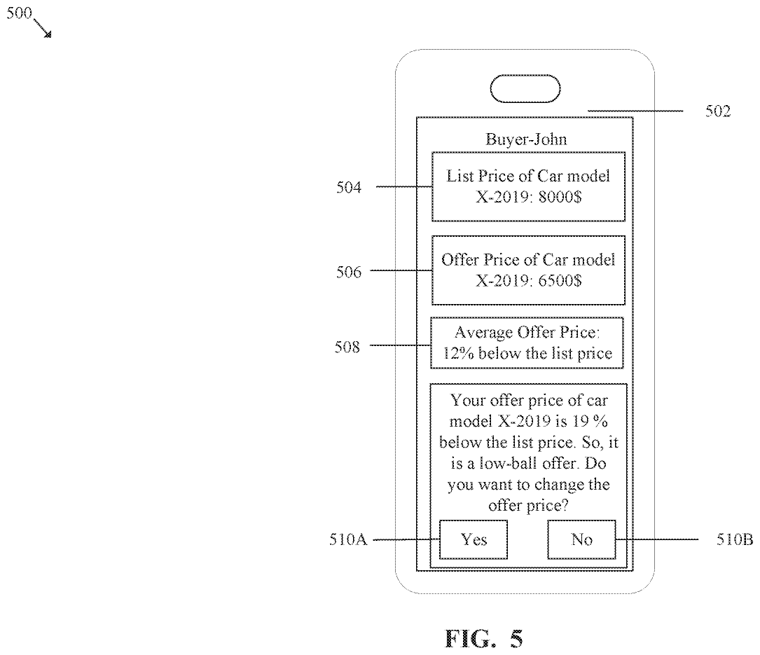

FIG. 5 is a diagram that illustrates an exemplary scenario for determination of the low-ball offer based on an average offer price associated with buyers other than a first buyer, in accordance with an embodiment of the disclosure. FIG. 5 is explained in conjunction with elements from FIG. 1, FIG. 2, FIG. 3, and FIG. 4. With reference to FIG. 5, there is shown an exemplary scenario 500. The exemplary scenario 500 may include a buyer device 502 associated with a first buyer (e.g., “John”). The buyer device 502 may display a first UI element 504, a second UI element 506, a third UI element 508, a fourth UI element 510, a fifth UI element 510A, and a sixth UI element 510B. The buyer device 502 may be implemented as a computing device. However, the buyer device 502 may be similar to the system 102 and may incorporate functionalities of the system 102. A set of operations associated with the exemplary scenario 500 is described herein

With reference, to FIG. 5, the first UI element 504 may provide the list price of the “car model X-2019” as “8000$”. The “car model X-2019” may be the first product that the first seller may want to sell off. The list price may be the first list price, as received from the first seller. The second UI element 406 may provide the first offer price for the “car model X-2019” as “6500$”. The control circuitry 202 may determine the average offer price below the first list price for the first product. The average offer price may be the average of offer prices from other buyers of products similar to the “car model X-2019”. It may be noted that buyers other than the first buyer “John” may have had made offers for the products similar to the “car model X-2019” in the past. Offer price made by each of the other buyers may be averaged to determine the average offer price. For example, three buyers may have made offers for the products similar to the “car model X-2019” in the past. The first offer price for the three other buyers may be “7000$”, “6900$”, and “6860$” respectively. Herein, the average of the first offer price for the three other buyers may be “7040$”. Thus, the average offer price may be “7040$” that be “12 percent” below the list price of “8000$”. The third UI element 508 may provide the average offer price as “12 percent” below the list price. The control circuitry 202 may determine that the first offer price “6500$” made by the first buyer “John” may be “19%” below the list price of “8000$”. Hence, the offer price “6500$” may be a predefined value (e.g., “400$” or 5% of the first list price of “8000$”) below the average offer price (e.g., “7040$”) and may thereby be determined as the low-ball offer. The first notification may be transmitted to the buyer device 502 related to the buyer “John”. The buyer device 502 may provide the transmitted first notification via the fourth UI element 510. For example, the fourth UI element 510 may be a pop up that may state that “the offer price of the “car model X-2019” may be “19%” below the list price, and hence, it is a low-ball offer”. Further, the fourth UI element 510 may prompt the first buyer “John” to indicate whether the first buyer (i.e., “John”) wants to change the first offer price. In case, the first buyer “John” wishes to change the first offer price made by him, the first buyer provide a selection input through the fifth UI element 510A. In case the first buyer “John” doesn't want to change the offer price made by him the first buyer may provide a selection input through the sixth UI element 510B.

As discussed, the first buyer “John” may change the first offer price based on the first notification. The first notification may allow the first buyer to know that the first offer price may be the low-ball offer and may not be notified to the first seller. The first buyer can then provide a second offer price based on the received first notification so that the second offer price is not the low-ball offer and gets notified to the first seller. However, in case the first buyer does not want to change the first offer price, the first buyer may simply look for better deals from other sellers.

It should be noted that the scenario 500 of FIG. 5 is for exemplary purpose and should not be construed to limit the scope of the disclosure.

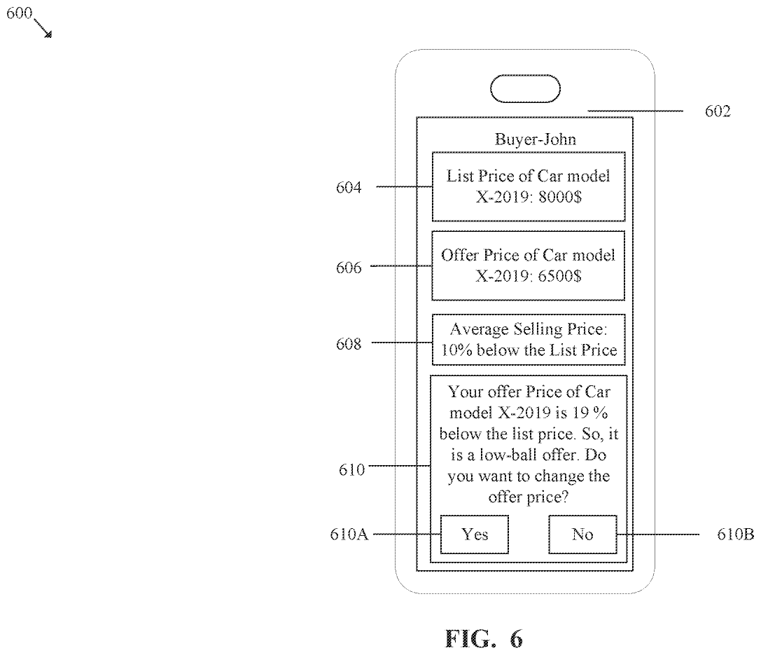

FIG. 6 is a diagram that illustrates an exemplary scenario for determination of the low-ball offer based on an average selling price associated with buyers other than a first buyer, in accordance with an embodiment of the disclosure. FIG. 6 is explained in conjunction with elements from FIG. 1, FIG. 2, FIG. 3, FIG. 4, and FIG. 5. With reference to FIG. 6, there is shown an exemplary scenario 600. The exemplary scenario 600 may include a buyer device 602 associated with a first buyer, such as, “John”. The buyer device 602 may display a first UI element 604, a second UI element 606, a third UI element 608, a fourth UI element 610, a fifth UI element 610A, and a sixth UI element 610B. The buyer device 602 may be implemented as a computing device. However, the buyer device 602 may be similar to the system 102 and may incorporate functionalities of the system 102. A set of operations associated with the exemplary scenario 600 is described herein

With reference, to FIG. 6, the first UI element 604 may provide the list price of the “car model X-2019” as “8000$”. The “car model X-2019” may be the first product that the first seller may want to sell off. The list price may be the first list price, as received from the first seller. The second UI element 606 may provide the offer price for the “car model X-2019” as “6500$”. The control circuitry 202 may determine the average selling price below the first list price for the first product.

As discussed, the selling price may be the actual price at which the products similar to “car model X-2019 may have been sold. Different buyers may purchase the products similar to the “car model X-2019” at different selling prices. The set of historical selling prices associated with the “car model X-2019” may be received. The set of historical selling prices may be the selling prices at which the set of buyers may have had purchased products similar to the “car model X-2019” in the past. The set of historical selling prices may be averaged to determine the average selling price for the “car model X-2019”. For example, three buyers may have purchased the products similar to the “car model X-2019” in the past. The selling price for the three buyers may be “7380$”, “6900$”, and “7220$” respectively. Herein, the average of the selling prices for the three buyers may be “7167$”. Thus, the average selling price may be “7167$” that may be “10 percent” below the list price of “8000$”. In an example, the third UI element 608 may provide the average selling price as “12 percent” below the list price. The control circuitry 202 may determine that the offer price “6500$” made by the first buyer “John” may be “19%” below the list price of “8000$”. Hence, the offer price “6500$” may be below the average selling price by a certain value (say, 5% of “8000$” or “400$”) and may be determined as the low-ball offer.

The first notification may be transmitted to the buyer device 602 related to the first buyer “John”. The buyer device 602 may provide the transmitted first notification via the fourth UI element 610. For example, the fourth UI element 610 may indicate that the offer price of the “car model X-2019” may be “19%” below the list price. Since, the offer price is lower than the average selling price, the offer price of “6500$” may be a low-ball offer. Further, the fourth UI element 610 may prompt the first buyer “John” to change the offer price. In case, the first buyer “John” wishes to change the offer price made, the first buyer may provide a selection input through the fifth UI element 610A. In case, the first buyer “John” doesn't want to change the offer price, the first buyer may provide a selection input through the sixth UI element 610B.

Thus, the buyer device 602 may allow the first buyer “John” to know that the first offer price may be the low-ball offer, which may not be notified to the first seller. The first buyer can then provide the second offer price based on the received first notification so that the second offer price is not below the average selling price and gets notified to the first seller.

It should be noted that the scenario 600 of FIG. 6 is for exemplary purpose and should not be construed to limit the scope of the disclosure.

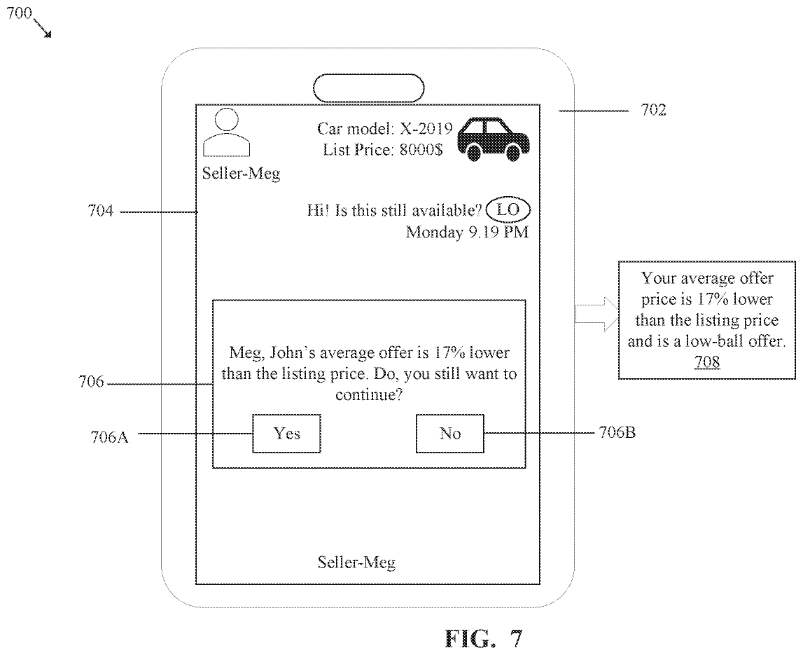

FIG. 7 is a diagram that illustrates an exemplary scenario for a second notification transmission, in accordance with an embodiment of the disclosure. FIG. 7 is explained in conjunction with elements from FIG. 1, FIG. 2, FIG. 3, FIG. 4, FIG. 5, and FIG. 6. With reference to FIG. 7, there is shown an exemplary scenario 700. The exemplary scenario 700 may include a seller device 702 associated with a first seller “Meg”. The seller device 702 may display a first UI element 704, a second UI element 706, a third UI element 706A, and a fourth UI element 706B. The seller device 702 may be implemented as a computing device. However, the seller device 702 may be similar to the system 102 and may incorporate functionalities of the system 102. The exemplary scenario 700 may further include an intermediate operation 708. A set of operations associated with the exemplary scenario 700 is described herein

With reference, to FIG. 7, the first UI element 704 may provide a query received via a chat from the first buyer. A first buyer “LO” may have queried the first seller “Meg” at “9.19 PM” on Monday regarding the “car model X-2019” having the list price of “8000$”. The first buyer “LO” may have made a set of historical offers for the products similar to the “car model X-2019”. The control circuitry 202 may determine the average offer price that the first buyer “LO” may have made in the past based on the set of historical offers associated with the first buyer “LO” for the products similar to the “car model X-2019”. For example, the control circuitry 202 may determine that the average offer price, provided by the first buyer “LO”, below the first list price for the “car model X-2019” may be “17%” lower than the listing price of “8000$”. The control circuitry 202 may notify the first seller “Meg” via the seller device 702 about the average offer price associated with the first buyer “LO” even before the first buyer “LO” makes an offer to the first seller “Meg”. The second UI element 706 may display “Meg, John's average offer is 17% lower than the listing price. Do, you still want to continue?”. The first seller “Meg” may compare the average office price of the first buyer “John” with the first list price to decide whether or not to interact with the first buyer “John”. In case, the first seller “Meg” wishes to continue with the first buyer “John”, the first seller “Meg” may provide a response “yes” through the third UI element 706A. In case, the first seller “Meg” does not wish to continue with the first buyer “John”, the first seller “Meg” may provide a response “no” through the fourth UI element 706B. In such cases the operation 708 may be executed. At 708, the first notification indicative of a message, such as, “Your average offer price is 17% lower than the listing price and is a low-ball offer.” may be displayed on the buyer device of the first buyer “John”.

As discussed, the first seller “Meg” may be intimated of the average offer price that the first buyer “John” may have offered for the products similar to the “car model X-2019”. That is, the first seller “Meg” may get an idea of the first offer price that the first buyer “John” may offer even before the first buyer “John” provides the first offer price for the “car model X-2019” based on the average offer price. In case, the average offer price made by the first buyer “John” for the products similar to the “car model X-2019” is the low-ball offer, then it may be expected that the first buyer “John” may make the low-ball offer again. Hence, the first seller “Meg” may not interact with the first buyer “John” and may not receive the first offer price for the “car model X-2019” from the first buyer “John”. This may save time of the first seller “Meg”.

It should be noted that the scenario 700 of FIG. 7 is for exemplary purpose and should not be construed to limit the scope of the disclosure.

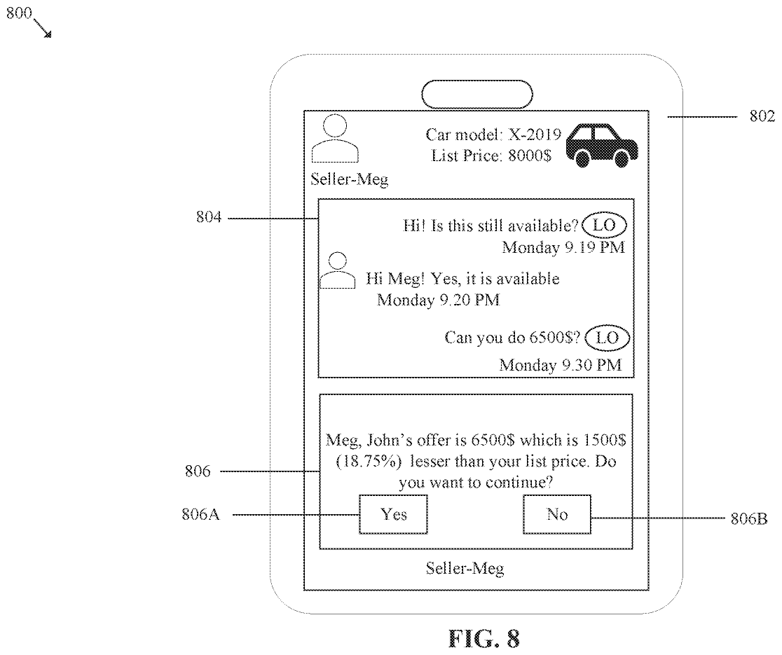

FIG. 8 is a diagram that illustrates an exemplary scenario for a first notification transmission based on a difference between a first offer price and a first list price, in accordance with an embodiment of the disclosure. FIG. 8 is explained in conjunction with elements from FIG. 1, FIG. 2, FIG. 3, FIG. 4, FIG. 5, FIG. 6, and FIG. 7. With reference to FIG. 8, there is shown an exemplary scenario 800. The exemplary scenario 800 may include a seller device 802 associated with a first seller “Meg”. The seller device 702 may display a first UI element 804, a second UI element 806, a third UI element 806A, and a fourth UI element 806B. The seller device 802 may be implemented as a computing device. However, the seller device 802 may be similar to the system 102 and may incorporate functionalities of the system 102. A set of operations associated with the exemplary scenario 800 is described herein

With reference, to FIG. 8, the first UI element 804 may provide a series of chats between the first buyer “LO” and the first seller “Meg”. Initially, the first buyer “LO” may have queried the first seller “Meg” at “9.19 PM” on Monday regarding the availability of the “car model X-2019” having the first list price of “8000$”. The first seller “Meg” may respond in affirmative that the “car model X-2019” is available. Thereafter, the first buyer “LO” may have provided the first offer price as “6500$” to the first seller “Meg” at “9.30 PM” on Monday. The control circuitry 202 may determine the difference between the received first offer price and the received first list price. Herein, the first offer price of “6500$” may be subtracted from the first list price of “8000$”. Thus, the difference may be determined as “1500$”. The first notification may provide the determined difference that may be displayed on the seller device 802. The second UI element 806 may indicate that, “Meg, John's offer is 6500$ which is 1500$ (or 18.75%) lesser than your list price. Do you want to continue?”. The second UI element 806 may provide a popup notification to display the transmitted first notification. The first seller “Meg” may be thus intimated of the determined difference and/or percentage of the difference with respect to the first list price. The first seller “Meg” may provide the response “yes” through the third UI element 806A, in case the first seller “Meg” wants to interact with the first buyer “John”. The first seller “Meg” may provide the response “no” through the fourth UI element 806B, in case the first seller “Meg” does not wants to interact with the first buyer “John”.

As discussed, the first seller “Meg” may be intimated of the determined difference. That is, the first seller “Meg” may get an idea of how much less the first offer price is from the first list price. Thus, the first seller “Meg” may make a better decision on whether or not to continue with the conversation with the first buyer “John”, based on the determined difference.

It should be noted that the scenario 800 of FIG. 8 is for exemplary purpose and should not be construed to limit the scope of the disclosure.

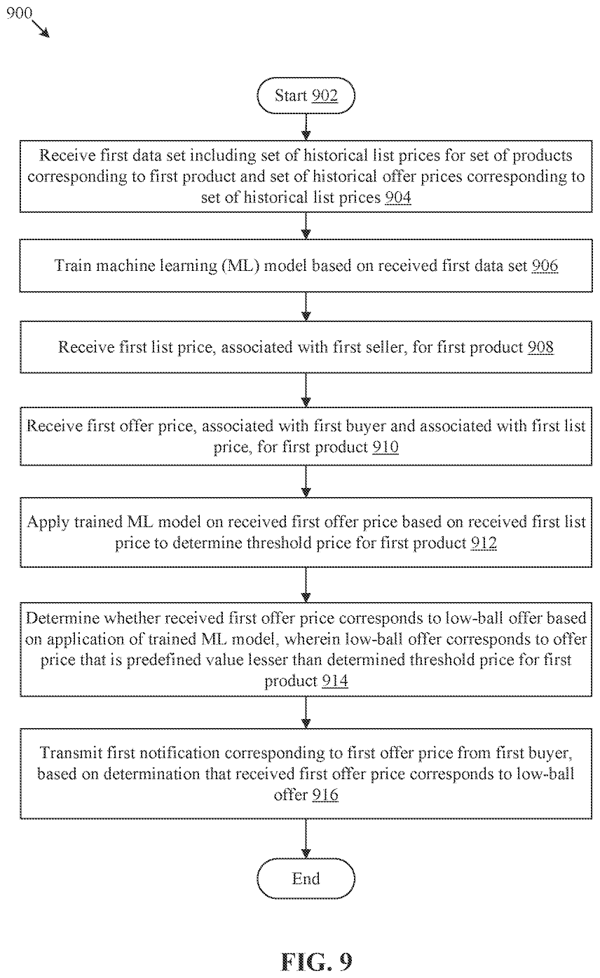

FIG. 9 is a diagram that illustrates a flowchart of an exemplary method for ML model based low-ball offer determination, in accordance with an embodiment of the disclosure. With reference to FIG. 9, there is shown a flowchart 900. The flowchart 900 is described in conjunction with FIG. 1, FIG. 2, FIG. 3, FIG. 4, FIG. 5, FIG. 6, FIG. 7, and FIG. 8. The operations from 902 to 916 may be implemented, for example, by the system 102 of FIG. 1 or the control circuitry 202 of FIG. 2. The operations of the flowchart 900 may start at 902 and proceed to 904.

At 904, the first data set 112 including the set of historical list prices 112A for the first product, and the set of historical offer prices 112B corresponding to the set of historical list prices 112A may be received. The control circuitry 202 may be configured to receive the first data set 112 including the set of historical list prices 112A for the first product, and the set of historical offer prices 112B corresponding to the set of historical list prices 112A. The first product may be a used product that the first seller may want to sell. The set of historical list prices 112A may be the list prices at which the set of sellers may have had advertised their first product on the platform in the past. The set of historical offer prices 112B may be first offer prices for the first product which the set of buyers may have had made in the past. Details about the set of historical list prices 112A and the set of historical offer prices 112B are further provided, for example, in FIG. 3 (at 302).

At 906, the machine learning (ML) model 110 may be trained based on the received first data set 112. The control circuitry 202 may be configured to train the machine learning (ML) model 110 based on the received first data set 112. The ML model 110 may be trained to determine the threshold price. Details about the machine learning (ML) model 110 are further provided, for example, in FIG. 3 (at 304).

At 908, the first list price (such as, the first list price 306A of FIG. 3), associated with the first seller, for the first product may be received. The control circuitry 202 may be configured to receive the first list price 306A, associated with the first seller, for the first product. The first list price 306A may be the first price at which the first seller may have listed the first product at a first time instant. Details about the first list price are further provided, for example, in FIG. 3 (at 306).

At 910, the first offer price (such as, the first offer price 308A of FIG. 3), associated with the first buyer and associated with the first list price (such as, the first list price 306A of FIG. 3), for the first product may be received. The control circuitry 202 may be configured to receive the first offer price 308A, associated with the first buyer and associated with the first list price 306A, for the first product. The first offer price 308A may the first price that the first buyer may quote for the first product a second time instant after the first time instant. It may be appreciated that the first offer price 308A may be lesser than the first list price 306A. Details about the first offer price 308A are further provided, for example, in FIG. 3 (at 308).

At 912, the trained ML model 110 may be applied on the received first offer price 308A based on the received first list price 306A to determine the threshold price 310A for the first product. The control circuitry 202 may be configured to apply the trained ML model 110 on the received first offer price 308A based on the received first list price 306A to determine the threshold price 310A for the first product. The threshold price may be a certain price or percent below the received first list price 306A. The determined threshold price 310A for the first product may correspond to the average offer price made by other buyers or the average selling price at which other buyers may have purchased the products similar to the first product. In some cases, the determined threshold price 310A for the first product may correspond to the average offer price made by the first buyer to other sellers for the products similar to the first product. Details about the first offer price 308A are further provided, for example, in FIG. 3 (at 310).

At 914, whether the received first offer price 308A corresponds to the low-ball offer based on the application of the trained ML model 110 may be determined. The low-ball offer may correspond to the offer price that may be the predefined value lesser than the determined threshold price for the first product. The control circuitry 202 may be configured to determine whether the received first offer price 308A corresponds to the low-ball offer based on the application of the trained ML model 110, wherein the low-ball offer may correspond to the offer price that may be the predefined value lesser than the determined threshold price for the first product. The trained ML model 110 may compare the received first offer price 308A with the determined threshold price to determine whether the received first offer price 308A is the low-ball offer or not. Details about the determination of the low-ball offer are further provided, for example, in FIG. 3 (at 312).

At 916, the first notification corresponding to the first offer price 308A from the first buyer may be transmitted, based on the determination that the received first offer price 308A corresponds to the low-ball offer. The control circuitry 202 may be configured to transmit the first notification corresponding to the first offer price 308A from the first buyer, based on the determination that the received first offer price 308A corresponds to the low-ball offer. The first notification may be either sent to the first buyer or the first seller depending on whether or not the received first offer price 308A corresponds to the low-ball offer. In case, the received first offer price 308A is determined as the low-ball offer, the first notification may be transmitted to the buyer device so that the first buyer may amend the first offer. In case, the received first offer price 308A is not determined as the low-ball offer, the first notification may be transmitted to the seller device so that the first seller may be informed of the first offer price made by the first buyer. Details about the first notification are further provided, for example, in FIG. 3 (at 314). Control may pass to end.

Although the flowchart 900 is illustrated as discrete operations, such as 904, 906, 908, 910, 912, 914, and 916 the disclosure is not so limited. Accordingly, in certain embodiments, such discrete operations may be further divided into additional operations, combined into fewer operations, or eliminated, depending on the particular implementation without detracting from the essence of the disclosed embodiments.

Various embodiments of the disclosure may provide non-transitory computer-readable medium having stored thereon. The computer-executable instructions may be executed by the system 102 may cause the system 102 to execute operations. The operations may include reception of a first data set (such as, the first data set 112 of FIG. 1) including a set of historical list prices (such as, the set of historical list prices 112A of FIG. 1) for a first product, and a set of historical offer prices (such as, the set of historical offer prices 112B of FIG. 1) corresponding to the set of historical list prices such as, the set of historical list prices 112A of FIG. 1). The operations may include training a machine learning (ML) model (such as, the machine learning (ML) model 110 of FIG. 1) based on the received first data set (such as, the first data set 112 of FIG. 1). The operations may further include reception of a first list price (such as, the first list price 306A of FIG. 3), associated with a first seller, for the first product. The operations may further include reception of a first offer price (such as, the first offer price 308A of FIG. 3), associated with a first buyer and associated with the first list price (such as, the first list price 306A of FIG. 3), for the first product. The operations may further include application of the trained ML model (such as, the ML model 110 of FIG. 1) on the received first offer price (such as, the first offer price 308A of FIG. 3) based on the received first list price (such as, the first list price 306A of FIG. 3) to determine a threshold price (such as, the threshold price 310A of FIG. 3) for the first product. The operations may further include determination of whether the received first offer price (such as, the first offer price 308A of FIG. 3) corresponds to a low-ball offer based on the application of the trained ML model (such as, the ML model 110 of FIG. 1). The low-ball offer may correspond to an offer price that may be a predefined value lesser than the determined threshold price for the first product. The operations may further include transmission of a first notification indicative of the first offer price (such as, the first offer price 308A of FIG. 3) from the first buyer, based on the determination that the received first offer price may correspond to the low-ball offer.

The present disclosure may be realized in hardware, or a combination of hardware and software. The present disclosure may be realized in a centralized fashion, in at least one computer system, or in a distributed fashion, where different elements may be spread across several interconnected computer systems. A computer system or other apparatus adapted for carrying out the methods described herein may be suited. A combination of hardware and software may be a general-purpose computer system with a computer program that, when loaded and executed, may control the computer system such that it carries out the methods described herein. The present disclosure may be realized in hardware that includes a portion of an integrated circuit that also performs other functions. It may be understood that, depending on the embodiment, some of the steps described above may be eliminated, while other additional steps may be added, and the sequence of steps may be changed.

The present disclosure may also be embedded in a computer program product, which includes all the features that enable the implementation of the methods described herein, and which when loaded in a computer system is able to carry out these methods. Computer program, in the present context, means any expression, in any language, code or notation, of a set of instructions intended to cause a system with an information processing capability to perform a particular function either directly, or after either or both of the following: a) conversion to another language, code or notation; b) reproduction in a different material form. While the present disclosure has been described with reference to certain embodiments, it will be understood by those skilled in the art that various changes may be made, and equivalents may be substituted without departing from the scope of the present disclosure. In addition, many modifications may be made to adapt a particular situation or material to the teachings of the present disclosure without departing from its scope. Therefore, it is intended that the present disclosure not be limited to the particular embodiment disclosed, but that the present disclosure will include all embodiments that fall within the scope of the appended claims.

1. A system, comprising:
control circuitry configured to:
receive a first data set including a set of historical list prices for a first product, and a set of historical offer prices corresponding to the set of historical list prices;
train a machine learning (ML) model based on the received first data set;
receive a first list price, associated with a first seller, for the first product;
receive a first offer price, associated with a first buyer and associated with the first list price, for the first product;
apply the trained ML model on the received first offer price based on the received first list price to determine a threshold price for the first product, wherein
the determined threshold price for the first product corresponds to an average offer price associated with the first buyer,
the average offer price is an average of the set of historical offer prices made by the first buyer to a plurality of sellers for a plurality of products similar to that of the first product,
the plurality of sellers is different from the first seller, and
the determined threshold price is less than the first list price;
determine whether the received first offer price corresponds to a low-ball offer based on the application of the trained ML model, wherein
the low-ball offer corresponds to an offer price that is a predefined value lesser than the determined threshold price for the first product;
transmit, to a buyer device related to the first buyer, a first notification corresponding to the first offer price from the first buyer, based on the determination that the received first offer price corresponds to the low-ball offer; and
transmit, to a seller device related to the first seller, the first notification corresponding to the first offer price from the first buyer, based on the determination that the received first offer price does not correspond to the low-ball offer.

2. (canceled)

3. The system according to claim 1, wherein the first product is a vehicle associated with vehicle information including at least one of a make, a model, a year, and a condition, associated with vehicle.

4. The system according to claim 1, wherein
the first data set further includes a set of historical selling prices associated with a set of buyers, for the first product, and
the determined threshold price for the first product corresponds to an average selling price, provided by the set of buyers, below the first list price for the first product.

5. The system according to claim 1, wherein
the first data set includes a set of historical offer prices associated with the first buyer for the first product.

6. The system according to claim 5, wherein the control circuitry is further configured to:
categorize the first buyer into a buyer category of a set of buyer categories based on the determined threshold price for the first product and on the average offer price provided by the first buyer; and
transmit a second notification indicative of the buyer category associated with the first buyer.

7. (canceled)

8. (canceled)

9. The system according to claim 1, wherein the control circuitry is further configured to:
receive first location information associated with the first seller;
receive second location information associated with the first buyer; and
compare the second location information with the first location information, wherein
the transmission of the first notification is further based on the comparison of the second location information and the first location information.

10. The system according to claim 1, wherein the control circuitry is further configured to:
determine a difference between the received first offer price and the received first list price, wherein
the transmitted first notification further indicates the determined difference between the received first offer price and the received first list price.

11. The system according to claim 1, wherein the control circuitry is further configured to:
update the first data set based on the received first list price and the received first offer price associated with the received first list price; and
re-train the ML model based on the updated first data set.

12. A method, comprising:
in a system:
receiving a first data set including a set of historical list prices for a first product, and a set of historical offer prices corresponding to the set of historical list prices;
training a machine learning (ML) model based on the received first data set;
receiving a first list price, associated with a first seller, for the first product;
receiving a first offer price, associated with a first buyer and associated with the first list price, for the first product;
applying the trained ML model on the received first offer price based on the received first list price to determine a threshold price for the first product, wherein
the determined threshold price for the first product corresponds to an average offer price associated with the first buyer,
the average offer price is an average of the set of historical offer prices made by the first buyer to a plurality of sellers for a plurality of products similar to that of the first product,
the plurality of sellers is different from the first seller, and
the determined threshold price is less than the first list price;
determining whether the received first offer price corresponds to a low-ball offer based on the application of the trained ML model, wherein
the low-ball offer corresponds to an offer price that is a predefined value lesser than the determined threshold price for the first product;
transmitting, to a buyer device related to the first buyer, a first notification indicative of the first offer price from the first buyer, based on the determination that the received first offer price corresponds to the low-ball offer; and
transmitting, to a seller device related to the first seller, the first notification corresponding to the first offer price from the first buyer, based on the determination that the received first offer price does not correspond to the low-ball offer.

13. (canceled)

14. The method according to claim 12, wherein
the first data set further includes a set of historical selling prices associated with a set of buyers, for the first product, and
the determined threshold price for the first product corresponds to an average selling price, provided by the set of buyers, below the first list price for the first product.

15. The method according to claim 12, wherein
the first data set includes a set of historical offer prices associated with the first buyer for the first product.

16. The method according to claim 15, further comprising:
categorizing the first buyer into a buyer category of a set of buyer categories based on the determined threshold price for the first product and on the average offer price provided by the first buyer; and
transmitting a second notification indicative of the buyer category associated with the first buyer.

17. (canceled)

18. (canceled)

19. The method according to claim 12, further comprising:
determining a difference between the received first offer price and the received first list price, wherein
the transmitted first notification further indicates the determined difference between the received first offer price and the received first list price.

20. A non-transitory computer-readable medium having stored thereon, computer-executable instructions that when executed by a system, causes the system to execute operations, the operations comprising:
receiving a first data set including a set of historical list prices for a first product, and a set of historical offer prices corresponding to the set of historical list prices;
training a machine learning (ML) model based on the received first data set;
receiving a first list price, associated with a first seller, for the first product;
receiving a first offer price, associated with a first buyer and associated with the first list price, for the first product;
applying the trained ML model on the received first offer price based on the received first list price to determine a threshold price for the first product, wherein
the determined threshold price for the first product corresponds to an average offer price associated with the first buyer,
the average offer price is an average of the set of historical offer prices made by the first buyer to a plurality of sellers for a plurality of products similar to that of the first product,
the plurality of sellers is different from the first seller, and
the determined threshold price is less than the first list price;
determining whether the received first offer price corresponds to a low-ball offer based on the application of the trained ML model, wherein
the low-ball offer corresponds to an offer price that is a predefined value lesser than the determined threshold price for the first product;
transmitting, to a buyer device related to the first buyer, a first notification indicative of the first offer price from the first buyer, based on the determination that the received first offer price corresponds to the low-ball offer; and
transmitting, to a seller device related to the first seller, the first notification corresponding to the first offer price from the first buyer, based on the determination that the received first offer price does not correspond to the low-ball offer.
